(19) United States
(12) Patent Application Publication
(10) Pub. No.: US 2004/0031880 A1
(43) Pub. Date: Feb. 19, 2004

(54) Aircraft and propulsion system for an aircraft, and operating method

(76) Inventors: Reiner Stemme, Hoenow (DE); Konrad Kauffmann, Caputh (DE)

Correspondence Address: HAHN LOESER & PARKS, LLP, TWIN OAKS ESTATE, 1225 W. MARKET STREET, AKRON, OH, 44313, US

(21) Appl. No.: 10/275,211

(22) PCT Filed: May 4, 2001
(86) PCT No.: PCT/EP01/05066

(30) Foreign Application Priority Data
May 5, 2000 (DE) 100-23-016.4

(51) Int. Cl. B64D 27/00

(52) U.S. Cl. 244/55

(57) ABSTRACT

The invention relates to a propulsion system for aircraft, especially for high-flying and long-distance flying unmanned aircraft, to the aircraft itself and to a method for controlling aircraft. Said propulsion system has a first jet turbine engine and a second jet turbine engine (22, 24). The invention also provides that the first jet turbine engine is a turbine engine (22) and the second jet turbine engine is an airscrew turbine engine (24). Said airscrew turbine engine (24) remains non-operational at least during the process for starting the aircraft (10).

The invention described here covers a propulsion system for aircraft conforming to the general category specified in claim 1, an aircraft conforming to the general category specified in claim 16, as well as a procedure for aircraft control, especially with respect to propulsion systems, according to the precharacterizing part of claim 39.

The acquisition of information by aircraft, whether for military purposes (reconnaissance) or civilian purposes (cartography, atmospheric research) frequently is conducted at high altitude. The aircraft is required to climb to these altitudes as rapidly as possible, and remain within the area of observation as long as possible. The elements of this requirement profile,—high altitude operation, rapid climb to the desired flight level, long endurance at altitude—contradict each other. Fast climbs to altitude can be achieved through the use of a suitable power plant. However, such power plants consume large amounts of fuel which have to be carried onboard the aircraft. Given limitations with respect to the amount of fuel that can be carried, this type of power plant will place severe limits on endurance over the target area. On the other hand, a power plant suitable for high altitude flight at low rates of fuel consumption raises the problem that it is either not at all suited for takeoff or landing phases of flight, or that climb to desired flight levels is of relatively long duration.

It is the objective of the present invention, to create a propulsion system of the kind specified initially, which allows for operation of aircraft at high altitude while achieving rapid climb rates and long endurance. Additionally, it is the objective of this invention to create an aircraft suitable for this task, providing the necessary control and guidance systems. The propulsion systems specified shall preferably be used for unmanned vehicles.

With respect to the propulsion system, the above objectives will be met by the characteristics specified in claim 5. Subsequent claims 6 through 15 specify additional design detail.

All details of the above aircraft requirement profile can be achieved when specifying a jet power plant which is mainly used during the takeoff phase of flight, and which can also be used during landing; an additional power plant-shall be driving a propeller. The propeller power plant allows for economical generation of power during high altitude cruise and/or long range phases of flight, whereas the jet power plant will be used for rapid climb through controlled airspace.

It is of advantage for the jet power plant to be of the turbine type, for this allows more economical use of fuel. Such turbine plant can burn Jet A fuel or light petroleum fuel known as Diesel fuel. Assuming the selection of a suitable jet engine as well as a suitable power plant driving the propeller, this offers the advantage of using only one type of fuel in both engines. This will ease operational logistics and simplify the design of fuel cells carried in the aircraft.

In principle, the power plant driving the propeller can be of a turbine type, for example, a turbo-prop power unit. Given the requirement for long endurance flight and a corresponding need for efficient use of fuel, a reciprocating engine is the preferred solution for driving the propeller.

If this reciprocating engine is of the Diesel type, it is possible (as mentioned previously) to use the same fuel as that used in the jet engine.

When the aircraft fitted with a propulsion system as specified in this invention is operated at high altitude, it will be of further advantage to fit a turbocharger to the reciprocating engine, preferably a two stage turbo charger. Also, it is preferred for the reciprocating engine to be equipped with an intercooler.

For high altitude op rations it has further proven to b advantageous for the propeller of the power plant driving th propeller to be configured as a high altitude propeller, preferably a two-bladed high altitude propeller, i.e. a propeller of greater diameter than would be required for efficient flight at higher air density at lower flight altitudes. An additional advantage results from combining it with the preferred propulsion control system—it is possible to use a propeller of such great diameter that it would otherwise impact the ground when the aircraft is in close proximity to the ground.

It is preferred to connect the high altitude propeller to the reciprocating power plant via a reduction gear. Combined with a large diameter propeller, this allows a) for a large mass of air to be accelerated relatively little, which can be done very efficiently, and b) it prevents the propeller blades from reaching the speed of sound, reducing the propeller's efficiency

In order to avoid ground damage of the high altitude propeller during takeoff or landing phases of flight, the propeller shall be aligned horizontally when the engine is not developing power and it may even be fixed in this horizontal parking position.

In order for the engine or the power plant driving the propeller to be started without turning the propeller (resulting in ground impact), the propeller of the power plant driving the propeller shall be linked to its engine via a clutch mechanism that can be engaged or disengaged independently from the engine. This can best be achieved by the use of an electrically activated hydraulic clutch. Also, the clutch will be used to hold the propeller in its parking position.

In order to reduce the drag of propeller blades in their horizontal parking position, the propeller shall be equipped with pitch control. This shall allow for full feather of propeller blades in the horizontal parking position of the propeller. Also, pitch control will allow for optimization of propeller efficiency according at different altitudes and forward speeds.

The propulsion system shall include a control unit connected to the first and the second power plant, configured in such a way that it will only be operating the first power plant during takeoff phases of flight; it will start the second power plant during a transition phase, and subsequently shut down the first power plant. An automatic control system of this kind will ensure that only the first power plant is used in proximity to the ground, while the second power plant driving the high altitude propeller will only be operated above a certain altitude. This prevents damage to the propeller and assures efficient operation of both power plants. In order to incorporate automatic fail-safe operation, the propulsion control system shall be configured such that the first power plant will be re-started if the second one should fail; and it will shut down the first engine, should the second engine resume its operation.

With respect to the aircraft, the objectives of this invention will be achieved through claim 16. Subsequent claims 17 through 37 specify additional design detail. The use of the propulsion system as specified in this invention meets the objectives stated for the overall system.

In order to minimize forces required for control of flight attitude, thus minimizing power requirements for servos and actuators in the aircraft, the aircraft shall be configured for positive in-flight stability. This results in a marked reduction of control inputs required for stable flight, so that the goal of minimal power requirements can be achieved with ease. Operational safety of the aircraft will also be enhanced. This feature is of great advantage in the case of un-manned operation of the aircraft.

In principle, the jet engine can be placed at any location in or on the fuselage. For the purposes of supporting positive in-flight stability, it has proven to be advantageous to mount the jet engine on top of the fuselage, preferably towards the tail of the aircraft. This configuration is of special advantage when other equipment is installed in the nose of the aircraft.

In order to reduce the jet engin's drag during the cruise phase of flight, th jet engine will b retract d into an ngine bay inside the fuselag . Retraction and extension of the jet engine into, or from the int mal engine bay can be achiev d in a variety of ways. One exampl is that of a telescoping mechanism, i.e. one that retracts or extends the engine at 90 degrees to the direction of air flowing into, respectively through the jet turbine. Alteratively, a parallelogram mechanism can be used. Or the engine can be retracted or extended using a tilting mechanism; this tilting mechanism will retract or extend the engine on one end of an arm which is rotated around an axis parallel to the lateral axis of the aircraft.

In order to further reduce the drag of the jet engine retracted into the internal engine bay, a door can be provided to cover the top of that compartment. This door shall be attached to the top of the jet engine.

In order to support the configuration for positive in-flight stability, the power plant or engine driving the propeller—including turbocharger and intercooler—shall be mounted inside the fuselage, at a location near the center of gravity or the center of lift. The link between engine and propeller shall be achieved via a shaft drive, incorporating the electrically activated hydraulic clutch.

As explained above, the aircraft's endurance over the target area can be maximized by reducing drag. For the air inlet of the propeller engine to help achieve this goal, the inlet shall be designed as a NACA scoop.

In principle, the propeller engine could be driving a propeller mounted at the tail of the aircraft. Locating the propeller at the nose of the fuselage, however, increases the efficiency of the propulsion system.

In principle, the wing of the aircraft specified in this invention can be mounted in any known configuration. Attaching the wing to the fuselage in a high wing configuration is the preferred solution.

As with wing configuration, any known wing geometry is possible. A wing of trapezoidal shape is preferred. This type of wing geometry shall be designed in a way that results in an elliptical distribution of lift along the wingspan, minimizing drag. Considering the desired use of the aircraft for long endurance flights at high altitude, a wing of large aspect ratio is preferred, using a laminar flow airfoil optimized for this operational profile.

When the jet engine is mounted on top of the rear fuselage, additional advantage can be gained from configuring the tail surfaces in a V-tail configuration.

In order to achieve minimal airframe weight and maximum strength while at the same time achieving skin surfaces of superior quality, fuselage and wings shall be made from carbon-composites.

In order for the aircraft specified in this invention to achieve high endurance within the assigned target area, the propeller engine must have low fuel consumption. To further support this, the aircraft shall have a glide ratio better than 20, i.e. the ratio of lift to drag (alternatively: forward speed to speed of descent) shall be better than 20:1. In other words, the aircraft specified in this invention can perform like a sailplane. This is of special advantage when both engines should fail, especially when the jet engine becomes inoperational.

In principle, the aircraft specified in this invention can be configured as a tricycle or as a conventional gear aircraft. Considering the requirements for placement of sensing equipment, a conventional gear configuration is preferred, using retractable main and tail gear and a steerable tailwheel.

In order for the fuselage to offer enough space for electronic cargo and/or avionics for aircraft control, and in order to not disrupt smooth airflow over the wings, the two main gear assemblies will be accommodated in pods m unted at som distance b low the wing; optionally, the gear can be retractable. Under-wing pods of this type can also be used for internal mounting of sensing equipment and other cargo items.

As detailed above, the aircraft specified in this invention will mainly be used for reconnaissance and surveillance. This requires a set of electronic devices to be mounted at various locations of the aircraft. Frequently, different mission profiles will require separate sensors and electronic modules. In order to accommodate these in a way that ensures positive in-flight stability of the aircraft, while at the same time allowing for easy exchange, the avionics packages required for unmanned flight, or, respectively, all electronic cargo shall be placed into an electronic cargo bay between the nose of the aircraft and the engine driving the propeller.

Electronic cargo can include a LOROP unit (Long Range Oblique Photography). The sensing unit of the LOROP system can be locked into an open bay underneath the fuselage, while the supporting electronics will be carried internally in electronic cargo bay on the right side of the fuselage. In place of the LOROP system, or in addition to it, a SAR (Synthetic Aperture Radar) unit can be installed—with the antenna unit held in the open bay under the left side of the fuselage, and the electronics carried in the internal electronic cargo bay on the right side.

For communication and data transfer between the aircraft and stationary or mobile units across long distance, a stabilized SAT-COM antenna for satellite communication can optionally be used. It will be mounted in an aerodynamically shaped cone on top of the fuselage between the nose and the engine driving the propeller; it shall have omnidirectional characteristics. The satellite communication system shall support remote piloting of the aircraft from long distance and/or transmission of data acquired by the aircraft. As an alternative or in addition, the optional retractable rotating antenna of an ESM/ELINT-system shall be mounted at the bottom of the fuselage, rearward of the propeller engine, radiating downward.

Antennae for short range data transfer—for example during remotely controlled takeoff and landing operations—can be mounted in under-wing cargo pods or in the gear pods.

An EO/IR sensing system can be mounted inside the stationary nose cone. This system will capture ground imagery—especially during approach to landing.

It seems obvious that the mission profile of the aircraft specified in this invention—namely high altitude operation of long endurance—can best be achieved with an unmanned vehicle.

This requires the aircraft specified in this invention to be remotely controlled using a remote control system. For this purpose, electronics for remote control and for flight control will be mounted in an electronics bay, preferably located on the right side of the fuselage between the nose and the propeller engine.

With respect to operating procedures, the objectives of this invention will be achieved through claim 38, subsequent claims 39 through 44 specify additional design detail.

As was briefly explained previously, the aircraft specified in this invention shall conduct takeoff operations with a non-operational propeller engine. This offers the potential for using a high altitude propeller of a diameter larger than would normally be possible when consideration is given to fuselage cross section, and/or limited ground clearance afforded by short gear legs. The diameter of this high altitude propeller can substantially exceed the cross section of the fuselage, its radius exceeding the distance between the ground and center of the fuselage as defined by the landing gear geometry. For takeoff, the high altitude propeller of the propeller engine will be placed in its horizontal parking position, and the jet engine will be used for takeoff. The jet engine will also be used for rapid climb above controlled airspace.

When r aching a first pre-determined altitud , th propeller engine shall b put into operation, while the jet engine continues to be operating.

When reaching a second pre-determined altitude, the jet engine can be shut down, and the propeller engine shall be started or continue to operate if it was started before.

Similar to the climb portion of flight following takeoff, during descending flight prior to landing, the jet engine shall be re-started when reaching a third pre-assigned altitude, while the propeller engine is still operating. When the aircraft descends to a fourth pre-determined altitude, the propeller engine shall be shut down, and the propeller shall be returned to its horizontal parking position.

In this context, mention should be made that in principle, the first, second, third, and fourth pre-determined altitudes can all be the same altitude, or that the second and third, and the first and fourth altitude can be the same pair of altitude, respectively.

In case of power failure of the propeller engine, the non-operating jet engine shall be re-started and take the aircraft to an emergency landing site. In order to achieve economical fuel consumption, intermittent use of the jet engine is specified.

Further advantages of the design and two examples of applications of the invention will be explained in Claims [0046] through [0071], using the attached figures. In this context, the terms “right”, “left”, “on top”, “below” refer to upright orientation of figures, as indicated by text and markings.

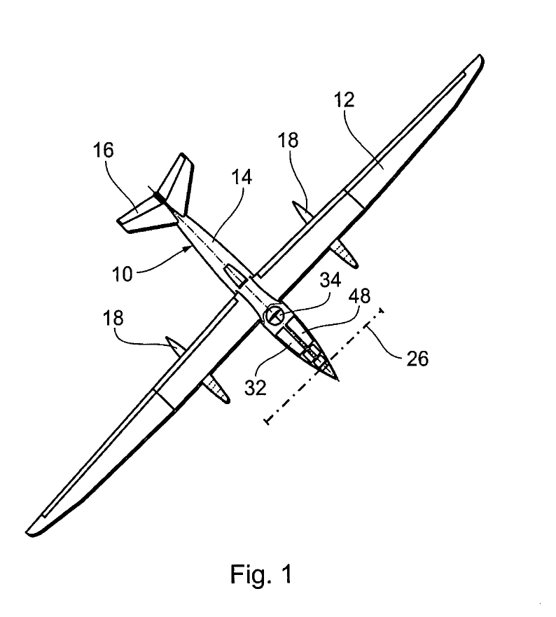

FIG. 1 is a plan view of the aircraft specified in this invention;

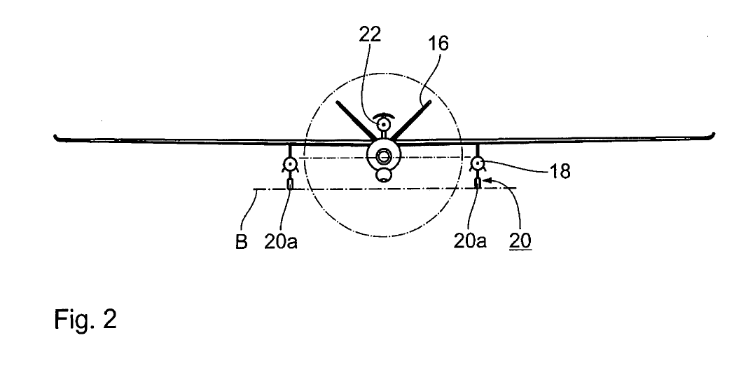

FIG. 2 is a frontal view of the aircraft shown in FIG. 1;

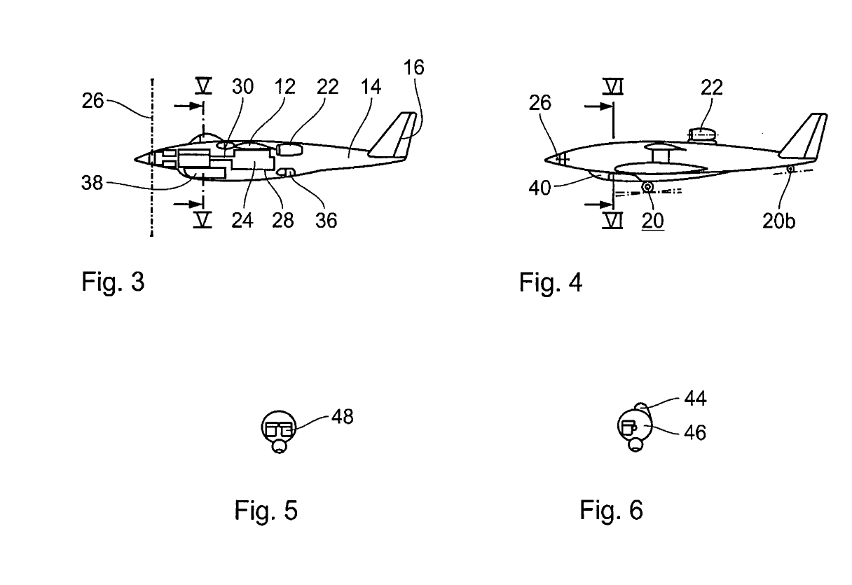

FIG. 3 is a side view of the aircraft, the jet engine retracted;

FIG. 4 is a side view similar to that in FIG. 3, with the jet engine and landing gear extended;

FIG. 5 is a cross section of the fuselage along a line from points V to V in FIG. 4;

FIG. 6 is a cross section of the fuselage along a line from points VI to VI in FIG. 3;

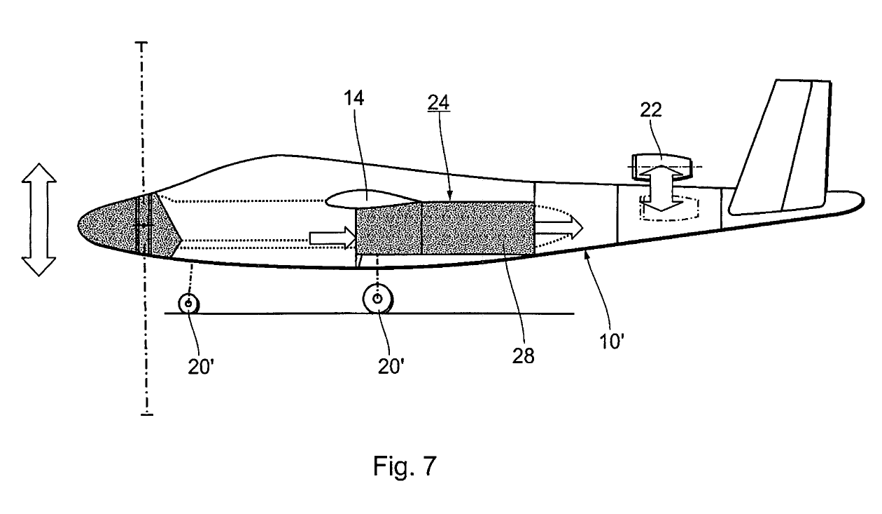

FIG. 7 is a side view of a second example of configuration of the aircraft specified in this invention; and

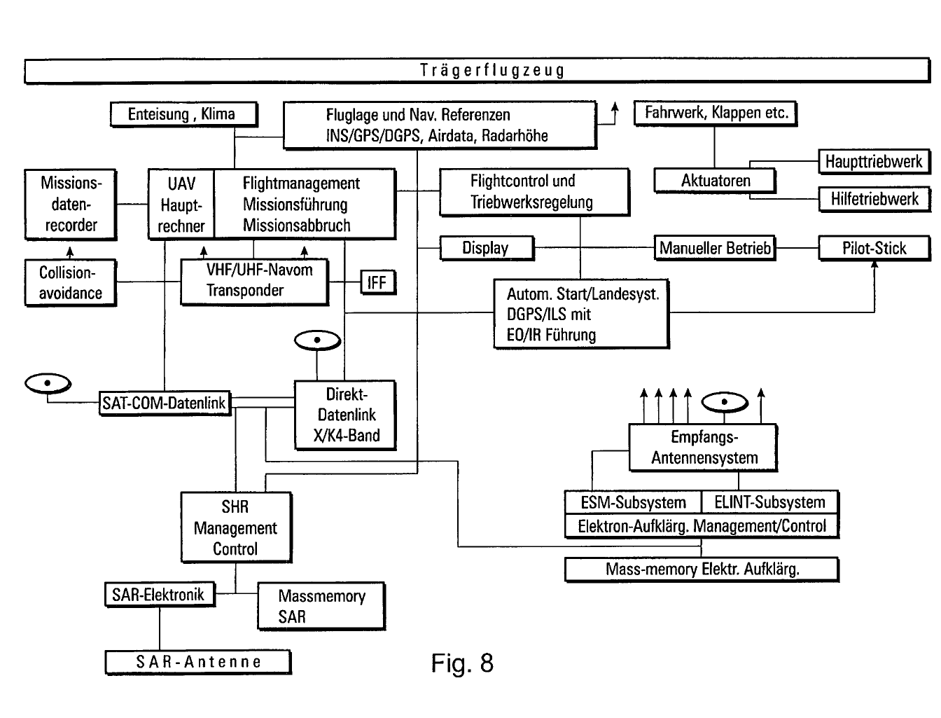

FIG. 8 is a graphic depiction of the various electronic components installed in the aircraft specified in this invention.

As can be seen in FIGS. 1 and 2, the aircraft specified in this invention (10) is of high wing configuration featuring wings of trapezoidal shape (12), and a fuselage (14) symmetrically aligned with the wings (12). The span of the wings (12) by far exceeds the length of the fuselage (14). The fuselage is of spherical cross section, and it resembles the shape of a cigar with pointed ends. A V-shaped tail section (16) is mounted at the rear of fuselage (14).

Below the wings (12), two cigar shaped pods (18) are mounted at some distance from, but parallel to the fuselage (14), which are suitable for containing the landing gear (20) (see FIGS. 2 and 4) as well as other electronic components which will be further detailed below.

Furthermore, the aircraft (10) specified in this invention is equipped with two independent power plants (22, 24) using diff rent principles of propulsion. On power plant (22) is a jet ngine, which as shown in FIGS. 3 and 4, and R is mounted on top of the rear fuselag (14).The jet ngine (22) can be in two positions relative to the fuselage (14). For one, as shown in FIG. 3, the jet engine (22) can be retracted into an engine bay inside the fuselage (no further illustration). The jet engine (22) shall not be operational in this position. Also, the jet engine (22) can vertically be extended in an upward direction from the engine bay, as shown in FIGS. 2 and 4. In this position, the jet engine shall be operational, its main use being to support takeoff and landing phases of flight. Retraction and extension of the jet engine (22) is achieved by means of a suitable telescoping mechanism that allows for space saving retraction and extension.

The second engine used in the aircraft (10) specified in this invention is a propeller engine (24) consisting of a two bladed propeller (26) and a reciprocating Diesel engine (28) equipped with turbocharger and intercooler. The propeller (26) is connected to the Diesel power plant (28) of the propeller engine via a reduction gear and a drive shaft (30). This may include an electrically activated clutch.

When the propeller engine (24) is not operational, the propeller (26) shall be moved into a horizontal parking position as shown in FIG. 1 and 4. The propeller can be held in this position by means of a suitable locking mechanism, which may be incorporated into the clutch (if so equipped). This horizontal parking position ensures that the propeller (26) will not incur damage during the takeoff and landing phases of flight.

As can be seen in FIG. 2, the radius of propeller (26) greatly exceeds the distance between the engine's axis of rotation and the ground (B). If the propeller were put into operation during takeoff or landing, it would consequently be destroyed. It should be mentioned that, although the radius of propeller (26) exceeds the distance between the lateral axis of the fuselage and the ground (B), its diameter nevertheless is smaller than the distance between the two under-wing pods (18) holding the landing gear.

As has been explained previously, the aircraft specified in this invention is equipped with a landing gear (20) which is configured to be of conventional gear type as shown in FIGS. 1 through 4. The landing gear (20) consists of two forward gear legs (20a) as well as a steerable tail gear (20b) which can be retracted into the fuselage (14).

The aircraft (10) specified in this invention can be used for different missions. The most advantageous use of the aircraft (10) specified in this invention will be reconnaissance missions. For this purpose, the aircraft (10) specified in this invention can be equipped with a series of electronic kits (32) which will be contained in an electronic cargo bay (not further detailed here), located between the propeller (26) and the reciprocating Diesel engine of the propeller engine (24). FIG. 1 shows associated electronic cargo (32).

For communication and data transfer over long distances, a SAT/COM antenna (34) is shown, mounted on top of the fuselage between the reciprocating engine (28) and the propeller (26).

Part of the electronic cargo load is a rotating antenna (36) mounted in the belly of the fuselage behind the reciprocating engine (28), in other words, between the reciprocating engine (28) and the tail section (16).

Furthermore, an open bay with locking mechanisms in the lower fuselage is configured for optional installation of a LOROP sensor or a SAR antenna. The electronics supporting this will be contained inside the electronics bay in the left forward side of the fuselage.

The aircraft (10) specified in this invention is designed to be piloted using remote control. FIGS. 3 and 6, however, show a variant, where for research and testing purposes, the aircraft (10) will be controlled by a pilot inside the aircraft. The pilot's seat is configured for the left side of the fuselage as shown in FIG. 6. Furthermore, a cabin canopy (44) is specified, and the electronic cargo load (48) must be removed. In contrast, FIGS. 4 and 5 show a variant, where aircraft (10) specified in this invention is flown using the remote control system (48) mentioned previously, the space previously used for a pilot can be used for the installation of electronic cargo.

FIG. 7 shows an alternative configuration of aircraft (10) specified in this invention, which differs from the aircraft shown in FIGS. 1 through 6, in that in place of a tail gear (20) it is equipped with a nose gear (20′). Also, FIG. 7 illustrates the trajectory of extending and retracting the jet engine (22) and the air inlet and outlet of the reciprocating engine (28) of the propeller engine (24). Conventional gear is the preferred configuration, however.

FIG. 8 depicts the electronic components of the aircraft (10) specified in this invention.

The aircraft (10) previously specified in this invention using a propulsion system as specified in this invention will be operated as follows: After appropriate pre-flight preparations, the jet engine (22) shall be extended upwards from the engine bay and readied for takeoff. The aircraft (10) is subsequently taxied to the runway. In case of the research version, this shall be controlled by a pilot onboard the aircraft, otherwise a remote control system (48) shall be used. When reaching rotation speed, the aircraft (10) will commence the climb phase of flight powered by the jet engine (22). After reaching a pre-determined altitude, the propeller engine (24) shall be put into operation; the jet engine (22) remaining operational during start-up of the propeller engine (24). Further climb, especially transition of controlled airspace will most efficiently be performed using both power plants, so that a high rate of climb can be achieved, minimizing duration of flight in controlled airspace, rapidly climbing to its target altitude above controlled airspace. If a clutch is provided between the power plant (28) and the propeller (26) of the propeller engine (24), the power plant (28) can be started without turning the propeller (26). The propeller (26) shall then be coupled to the power plant (28) via the clutch when it has reached a certain RPM. As an alternative to this preferred simultaneous operation of jet engine (22) and propeller engine (24), the jet engine (22) can be shut down and retracted into the engine bay when the propeller engine is operational.

The aircraft (10) shall be climbed to the desired flight level using the propeller engine (24) and the jet engine (22), beginning cruise flight at that altitude. Shut down of the jet engine (22) and transition to cruise flight (which may include residual climb), are determined by mission requirements, as well as by power output and fuel consumption of the jet engine at that altitude. In the case of malfunction of the propeller engine (24) during cruise flight, the jet engine (22) can again be extended from the engine bay and put into operation. In order to save fuel, the jet engine (22) shall be operated intermittently. Use of the jet engine shall be governed by requirements for economical fuel use, thus maximizing remaining distance.

As was pointed out before, the aircraft (10) specified in this invention is configured in such a way that even in the case of a failure of both the jet engine (22) and the propeller engine (24) the aircraft (10) will transition to controlled glide, which enables it to reach an emergency landing site.

In normal operations, the aircraft (10) specified in this invention will leave its cruise altitude in preparation for landing, descending to an altitude where the jet engine (22) can be extended from its engine bay, and can then be started. The propeller engine (24) shall be shut down as soon as the jet engine is started, or it shall it will be shut down after a certain delay. The propeller (26) shall then be moved to its horizontal parking position and locked in that position (if so equipped), the propeller blades will moved to full feather. The jet engine (22) shall be used for the approach to landing and the landing itself, also it will be used to taxi the aircraft (10) to a parking position. This procedure can be conducted under full automatic control, or it can be achieved via the actions of a ground based control facility, which, for the purpose of remotely controlling the landing procedure, will receive image data depicting the approach scenario as transmitted from th EO/IR system mounted in the nose of the aircraft.

1) Aircraft, in particular unmanned aircraft flying long distances at high altitude, with at least a first and at least a second power plant (22, 24), characterized by the fact that the first power plant is a jet engine (22) and the second power plant is a reciprocating propeller engine, and both power plants can be operated on the same fuel.

2) Aircraft according to claim (1), characterized by a configuration for positive in-flight stability.

3) Aircraft according to claims (1) or (2), characterized by the fact that the jet engine (22) is mounted on top of the fuselage (14), preferably on the rear section of the fuselage.

4) Aircraft according to claims (1) through (3), characterized by the fact that the jet engine (22) can be retracted into an engine bay inside the fuselage (14) of the aircraft (10).

5) Aircraft according to claim (4), characterized by the fact that the engine bay can be covered by a door (23) which is attached to the jet engine (22).

6) Aircraft according to one of the claims (1) through (5), characterized by the fact that the power plant (28) of the propeller engine (24) is mounted in approximately the lateral center of the fuselage (14), close to the center of lift.

7) Aircraft according to one of the claims (1) through (6), characterized by the fact that the propeller (26) of the propeller engine (24) is mounted in the nose of the fuselage.

8) Aircraft according to one of the claims (1) through (7), characterized by a high wing configuration.

9) Aircraft according to one of the claims (1) through (8), characterized by the fact that the wing is of large aspect ratio, using laminar flow airfoil.

10) Aircraft according to one of the claims (1) through (9), characterized by the fact that the tail section (16) is of a V-tail configuration.

11) Aircraft according to one of the claims (1) through (10), characterized by the fact that the fuselage (14) and the wings are of carbon-composite construction.

12) Aircraft according to one of the claims (1) through (11), characterized by an aerodynamic configuration resulting in a glide ratio better than 20:1.

13) Aircraft according to one of the claims (1) through (12), characterized by landing gear preferably configured with a retractable and steerable tail wheel (20).

14) Aircraft according to claim (13), characterized by the fact that the main landing gear legs (20a, 20b) are contained in pods mounted underneath the wings (14) into the which the landing gear can optionally be retracted.

15) Aircraft according to one of the claims (1) through (14), characterized by an electronics bay for electronic cargo (32), preferably located between the nose of the fuselage and the power plant (28) of the propeller engine (24).

16) Aircraft according to one of the claims (1) through (15), characterized by a LOROP unit (38), pr ferably position d in the fuselage, between th power plant (28) of the propeller engine (24) and the nose of the aircraft.

17) Aircraft according to one of the claims (1) through (16), characterized by a SAR unit (40) mounted in the fuselage, preferably between the power plant (28) of the propeller engine (24) and the nose of the aircraft.

18) Aircraft according to one of the claims (1) through (17), characterized by a SAT/COM antenna (34) mounted inside the upper part of the fuselage, preferably between the power plant (28) of the propeller engine (24) and the nose of the aircraft.

19) Aircraft according to one of the claims (1) through (18), characterized by a rotating antenna (36) for ES/ELIMT mounted in the fuselage, preferably between the power plant (28) of the propeller engine (24) and the tail of the of the aircraft.

20) Aircraft according to one of the claims (1) through (19), characterized by an antenna for transmission of data mounted in a pod (18) underneath the wing (14), preferably intended to contain a gear leg (20a or 20b).

21) Aircraft according to one of the claims (1) through (20), characterized by the fact that a EO/IR system is mounted in the nose of the fuselage.

22) Aircraft according to one of the claims (1) through (21), characterized by a remote control unit (48), by means of which the aircraft (10) can to be controlled remotely.

23) Aircraft according to claim (22), characterized by the fact that the electronics for remote control (48) are carried in an electronics bay, preferably located between the power plant (28) of the propeller engine (24) and the nose of the aircraft.

24) Propulsion system for aircraft according to claims (1) through (24), in particular unmanned aircraft flying long distance at high altitude having at least a first and a at least second power plant (22), characterized by the fact that the first power plant is a jet engine (22) and the second power plant is a reciprocating propeller engine, and both power plants can be operated on the same fuel.

25) Propulsion system according to claim (24), characterized by an engine control system making the propeller engine (24) non-functional during takeoff operations of the aircraft (10).

26) Propulsion system according to claims (24) or (25), characterized by the fact that the jet turbine (22) is operated on light petroleum (Diesel) fuel.

27) Propulsion system according to claim (24) through (26), characterized by the fact that the reciprocating engine is a reciprocating Diesel engine (24).

28 Propulsion system according to claims (27, characterized by the fact that the reciprocating engine (24) shall be equipped with a turbo charger, preferably a two stage unit.

29) Propulsion system according to claims (27) or (28), characterized by the fact that the reciprocating engine (24) shall be equipped with an intercooler system.

30) Propulsion system according to claims (24) through (29), characterized by the fact that the propeller of the propeller engine (24) preferably is a two bladed, high altitude propeller (26).

31) Propulsion system according to claims (24) through (30), characterized by the fact that the propeller (26) can, when the propeller engine (24) is shut down, be moved to a horizontal parking position and can optionally be locked in that position.

32) Propulsion system according to claims (24) through (31), characterized by the fact that the propeller (26) of the propeller engine (24) shall be coupled to the power plant via a clutch, in particular an electromagnetic clutch.

33) Propulsion system according to claims (31) or (32), characterized by the fact that the optional locking of the propeller (26) shall be achieved via the clutch.

34) Propulsion system according to claims (24) through (33), characterized by the fact that the propeller (26) of the propeller engine (24) is coupled to the power plant (28) via a reduction gear.

35) Propulsion system according to claims (24) through (34), characterized by the fact that the propeller (26) of the propeller engine (24) is equipped with propeller pitch control.

36) Propulsion system according to claims (24) through (35), characterized by the fact that a propulsion control unit is connected to the first and the second engine, and is configured such that at least during the takeoff phase of flight, it will start up the first engine and prevent operation of the second engine, and that will operate both engines for a transitional phase when the aircraft has sufficient altitude above ground, and will subsequently shut down the first engine.

37) Propulsion system according to claim (36), characterized by the fact that the propulsion control unit is configured in such a way, that the first engine shall be re-started in the case of malfunction of the second engine.

38) Propulsion system according to claim (37), characterized by the fact that the propulsion control unit is configured in such a way, that the second engine shall be shut down, once the first engine has been made operational again.

39) Procedures for controlling an aircraft, especially an aircraft according to claims (1) through (23), which is equipped with a propulsion system comprising of at least one jet engine and at least one propeller engine, particularly a propulsion system according to claims (24) through (38), characterized by the fact that at least the takeoff phase of flight is conducted using the jet engine, with the propeller engine inoperational.

40) Procedures according to claim (39), characterized by the fact that the propeller engine shall be put into operation upon reaching a first pre-determined altitude subsequent to takeoff, during the climb phase of flight, while the jet engine continues to be operating.

41) Procedures according to claims (39) or (40), characterized by the fact that when reaching a second pre-determined altitude, the jet engine shall be shut down, and the propeller engine is started up or continues to operate if it was started before.

42) Procedures according to claims (39) through (41), characterized by the fact that during descending flight prior to landing, the jet engine shall be re-started upon reaching a third pre-assigned altitude, while the propeller engine is still operating.

43) Procedures according to claims (39) through (42), characterized by the fact that upon reaching a fourth pre-determined altitude, the propeller engine shall be shut down, and the propeller shall be returned to its horizontal parking position.

44) Procedures according to claims (39) through (43), characterized by the fact that in case of power failure of the propeller engine during cruise, the jet engine can be re-started for intermittent use.
